(19) United States
(12) Patent Application Publication
(10) Pub. No.: US 2002/0003939 A1
(43) Pub. Date: Jan. 10, 2002

(54) APPARATUS FOR RETAINING EXCESS FIBER OPTIC CABLE IN AN AERIAL INSTALLATION

(76) Inventors: ERIC J. HERMSEN, HOWELL, NJ (US); STANLEY B. KRAWIEC, MANALAPAN, NJ (US)

Correspondence Address: ANTEC CORPORATION, 11450 TECHNOLOGY CIRCLE, DULUTH, GA, 30097, US

(21) Appl. No.: 09/151,328

(22) Filed: Sep. 11, 1998

Related U.S. Application Data
(60) Provisional application No. 60/062,539, filed on Oct. 17, 1997.

(51) Int. Cl. G02B 6/00

(52) U.S. Cl. 385/135

(57) ABSTRACT

A fiber optic cable storage apparatus for storing excess cable in an aerial installation such as on an utility pole. The apparatus is generally planar and somewhat oval shaped and includes a channel extending around its periphery for retaining the cable. The channel includes a bottom wall and opposing sidewalls, the bottom being generally perpendicular and the sidewalls being generally parallel to the plane of the apparatus. The orientation of the bottom wall sidewalls allows the cable to be retained within the channel when the apparatus is installed horizontally, vertically, or any orientation. Each sidewall of the channel includes alternating rectangular sidewall sections. The sidewall sections are formed such that a section of one sidewall is not opposed by a section of the opposing sidewall. In this manner, the apparatus having alternating rectangular sidewall sections can be integrally formed from plastic using opposing die halves. One die half includes projections that form the rectangular sidewall sections of one sidewall and the other die half includes similar projections that form the sidewall sections of the opposing sidewall.

### CROSS-REFERENCE TO RELATED APPLICATION

The present application claims the benefit of priority of U.S. Provisional Patent Application Ser. No. 60/062,539 filed Oct. 17, 1997, entitled “Apparatus for Retaining Excess Fiber Optic Cable in an Aerial Installation”.

### TECHNICAL FIELD

The present invention relates to a storage device for retaining an excess length of fiber optic cable in an aerial installation.

### BACKGROUND OF THE INVENTION

The use of fiber optic cable as a transmission medium is common in communication systems, including cable television systems. The fiber optic cable (hereinafter referred to as “the cable”) is a single cable within which is provided a plurality of individual optical fibers. Each fiber within the cable may be used to transmit voice or data via light signals.

The proper transmission of light signals is dependent upon the integrity of the cable. Because the cable is somewhat delicate and prone to damage, it is imperative that the cable be installed and maintained free of any kinks or other damage.

One of the most important parameters of the cable is its “minimum bend radius.” The minimum bend radius of different cables may be different depending upon parameters such as the diameter of each particular cable. If a cable is bent beyond its minimum bend radius, the cable will sustain damage that will degrade its transmission performance. Therefore, it is important that the cable be installed and maintained such that it is prevented from being bent beyond its minimum bend radius.

The increased demand for telephone and data services requires an adequate system at the lowest cost. In many geographic areas, particularly rural areas, the most feasible method of cable installation is an aerial installation on utility poles. When the cable is installed on such utility poles, it is advantageous to include an excess portion of the cable, or “slack”, in case installation changes are required.

The prior art includes two devices for retaining cable in an aerial installation. U.S. Pat. No 5,092,663 describes an apparatus made of aluminum that provides a u-shaped channel for holding the slack. The unshaped channel has a bottom wall that is perpendicular to and sidewalls that are parallel to the plane of the device. However, the structure of the device as described in the '663 patent, particularly the solid sidewalls, make it inappropriate for formation by plastic molding because the mold tooling would be very expensive. The use of metal also makes the device in the '663 patent heavy and therefore more difficult and costly for technicians to install.

U.S. Pat. No. 5,408,571 describes a cable storage device that is made of plastic. The structure of this device makes it possible for manufacture by injection molding, thereby resulting in a lighter and lower cost device. However, to make this device moldable, the device is manufactured with a unshaped channel that has sidewalls that are perpendicular to the plane of the device. The channel, when oriented in this manner, does not properly retain the cable because the sidewalls of the channel do not prevent the cable from slipping out of the channel when the cable is pulled taut. Also, the device described in the '571 patent is not able to retain as much cable as the device of the '663 patent because the extra cable increases the likelihood that the cable will slip out of the channel.

FIG. 1 shows the device of the '571 patent installed in a vertical orientation. The device, generally shown at 8, includes a channel 12 having a bottom 14 and opposing sidewalls 16a, 16b. As shown in FIG. 1, the cable 11 is not adequately retained within the channel because the sidewalls 16a, 16b do not prevent the cable 111 from slipping out of the channel 12 in the direction shown by the arrow. It will be understood that although FIG. 1 shows the device of the '571 patent in a vertical orientation, the cable is susceptible to slipping out of the channel when the device is installed in any orientation.

Therefore, a need exists for a fiber optic cable storage device that can be constructed by plastic molding and that includes a channel having sidewalls that are parallel to the plane of the device such that the cable is retained within the channel when the device is aerially installed in any orientation.

### SUMMARY OF THE INVENTION

The present invention is a fiber optic cable storage apparatus for mounting in an aerial installation. The apparatus is generally planar and somewhat oval shaped and includes a channel extending around its periphery for retaining the cable.

The channel includes a bottom wall and opposing sidewalls, the bottom being generally perpendicular and the sidewalls being generally parallel to the plane of the apparatus. The orientation of the bottom wall sidewalls allows the cable to be retained within the channel when the apparatus is installed horizontally, vertically, or in any orientation.

The apparatus of the present invention is preferably molded from plastic. To enable the apparatus to be efficiently molded, each sidewall of the channel includes alternating rectangular sidewall sections. The sidewall sections are formed such that a section of one sidewall is not opposed by a section on the opposing sidewall. In this manner, the apparatus having the alternating rectangular sidewall sections can be integrally formed from plastic using opposing die halves. One die half includes projections that form the rectangular sidewall sections of one sidewall, and the other die half includes similar projections that form the rectangular sidewall sections of the opposing sidewall.

### BRIEF DESCRIPTION OF THE DRAWINGS

FIG. 1 is a cross-sectional view of a prior art device installed in a vertical orientation.

FIG. 2 is a top view of the apparatus of the present invention.

FIG. 3 is the side view of the apparatus of the present invention.

FIG. 4 is the isometric view of the apparatus of the present invention.

FIG. 5 is an exemplary representation of the installation of the apparatus of the present invention.

FIG. 6 is a cross-sectional view of the present invention installed in a vertical orientation, taken along line 6-6 of FIG. 2.

FIG. 7 is an example of the edge of the two steel dies used for molding the channel of the present invention.

### DETAILED DESCRIPTION OF THE PREFERRED EMBODIMENT

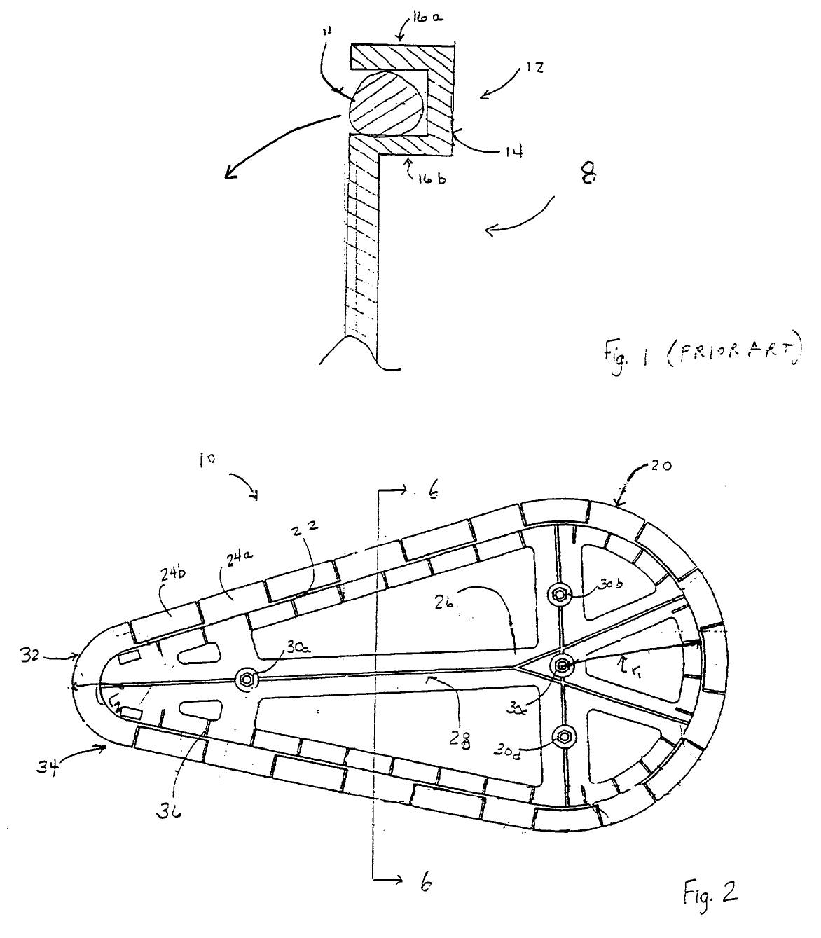

The preferred embodiment of the present invention for retaining excess fiber optic cable in an aerial installation is shown in the attached figures and described herein. The present invention is shown in FIG. 2 as apparatus 10. The shape of the apparatus 10 is generally oval with non-equal end radii (r₁, r₂). The apparatus 10 includes a channel 20 around its periphery. The channel 20 includes a bottom 22 and opposing sidewalls 24a, 24b. The channel is dimensioned to retain at least one cable. The end radius r₁ is at least equal to the minimum bend radius of the cable to be retained in the channel 20. This protects the cable from damage by preventing the cable from being bent beyond its minimum bend radius. The end radius r₂ is preferably dimensioned small enough to allow the entry port 32 and exit port 34 of the channel 20 to be in close proximity.

The channel 20 is supported by a main deck 26. The main deck 26 comprises support spines 28 which support the channel 20. Provided in the support spines 28 are connection holes 30a, 30b, 30c, 30d which are used to connect the apparatus 10 to a support system such as an aerial messenger cable strung between utility poles. Additional support is provided to the connection between the main deck 26 and the channel 20 via channel support spines 36.

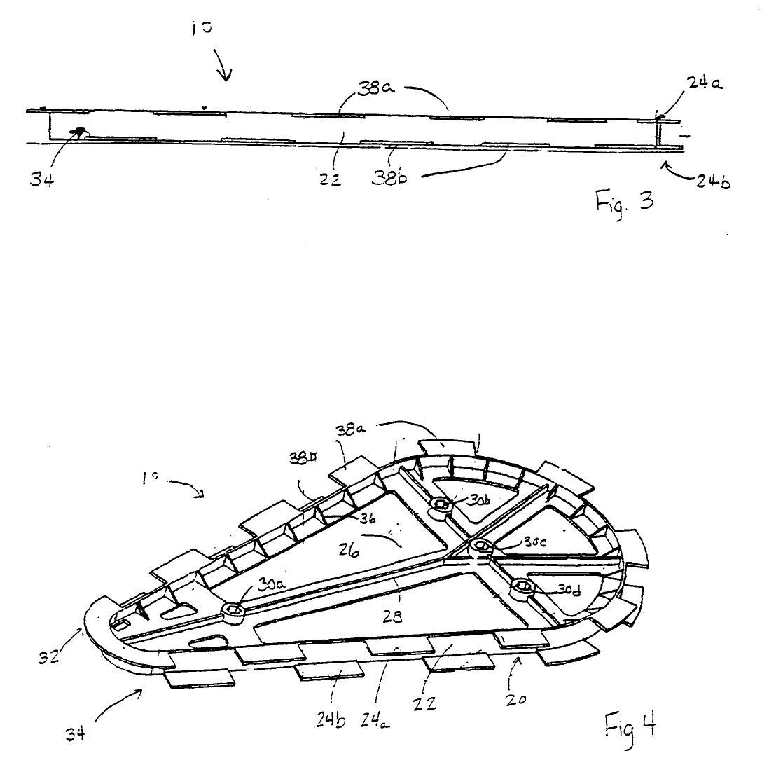

FIGS. 3 and 4 show the alternating sidewall sections 38a, 38b of each of the opposing sidewalls 24a, 24b. It is seen how each rectangular sidewall section 38a of sidewall 24a is not opposed by a sidewall section 38b of the opposing sidewall 24b. Similarly, each rectangular sidewall section 38b of sidewall 24b is not opposed by a sidewall section 38a of the opposing sidewall 24a. The distance between each alternating rectangular sidewall section on one sidewall is at least as great as the length of the opposite sidewall section. Forming the sidewalls in this manner allows the apparatus 10 to be injection molded of plastic, as will be discussed further below.

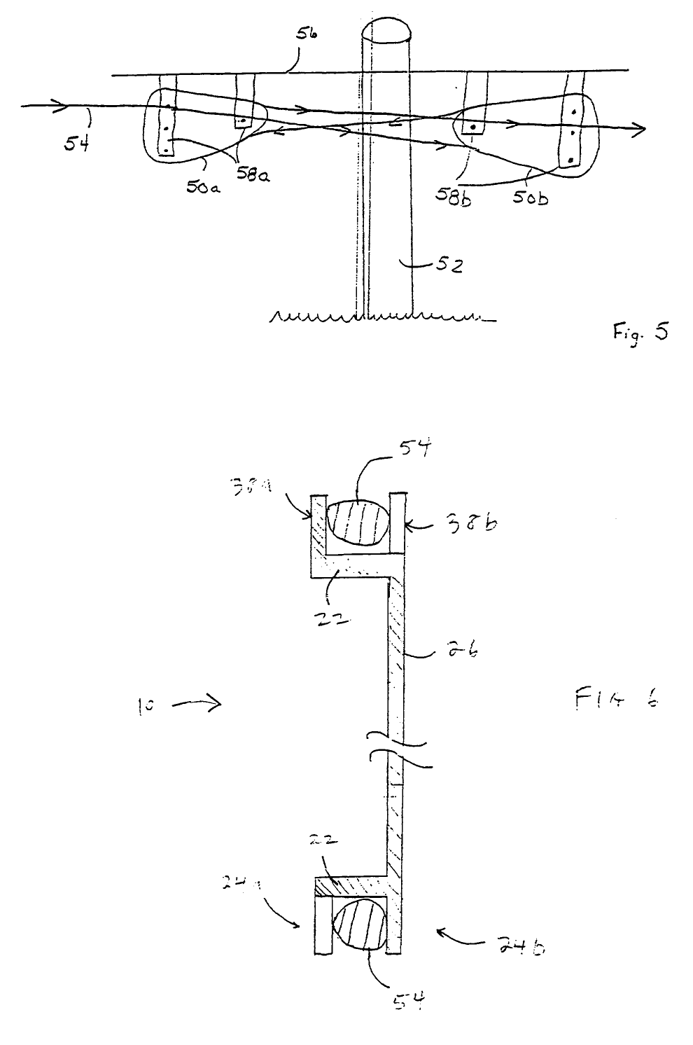

FIG. 5 shows an example of the installation of the apparatus of the present invention. In operation, two of the apparatus are used to store the slack. Apparatus 50a, 50b are installed in opposite directions and are preferably installed on opposite sides of the utility pole 52. The cable 54 is placed within the channel of each apparatus in the direction of the arrows. Each apparatus are hung from the messenger cable 56 via hangers 58a, 58b. In this example, the amount of slack that is stored is over two times the distance between the apparatus 50a and 50b. As the technician installs the cable, the cable is pulled taut into the channel of each apparatus to retain the cable or cables within the respective channels. When the cable is pulled against the bottom of the channel, the sidewalls prevent the cable from slipping out of the channel. In this manner, the slack is retained by the apparatus.

Although FIG. 5 shows a single cable being stored in the channel of each apparatus, it should be understood that a single cable can be wrapped multiple times around both apparatus 50a, 50b depending upon the dimensions of the channel and the cable. Similarly, multiple cables can be wrapped around both apparatus. These multiple methods expand the versatility of the apparatus.

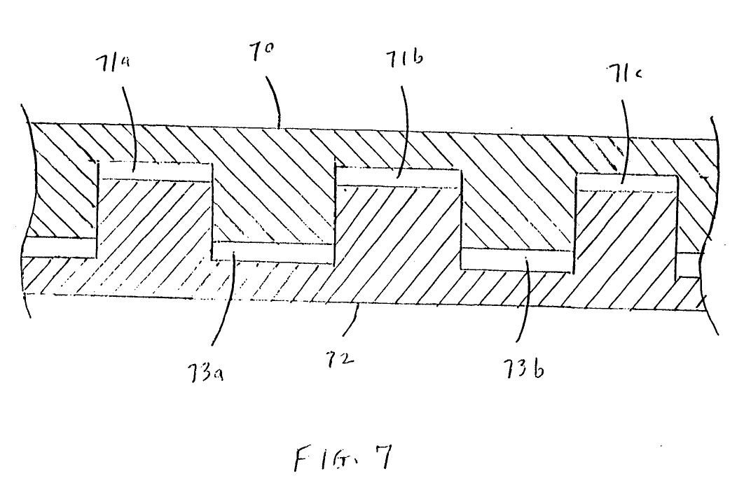

FIG. 6 shows a cable 54 installed within the channel. As discussed above, the cable 54 is pulled taut when installed within the channel. It is seen that the bottom wall 22 of the channel is perpendicular to the main deck 26 so when the cable is pulled into the channel, the tension pulls the cable against the bottom wall and the sidewalls prevent the cable from slipping out of the channel. This is an improvement over the prior art device, as shown in FIG. 1, in which the cable, when pulled taut during installation against sidewall 16b, may slip out of the channel 12 due to the lack of sidewall support.

FIG. 7 shows an example of two die halves that may be used to mold the apparatus of the present invention. The first die element 70 interlocks between the second die element 72 to define the alternating sidewall sections 71a, 71b, 71c of one sidewall and alternating sidewall sections 73a, 73b of the opposing sidewall. Without the alternating sidewall sections, the apparatus could not be molded with this simple tooling approach such that the sidewalls are parallel to the main deck 26. The design of the apparatus with alternating sidewall sections also uses less material which reduces material cost as well as the overall weight of the apparatus.

To manufacture the apparatus, the two die halves are placed together such that the die elements 70 and 72 interlock. The fluid plastic is then injected into the spaces left between the die elements 70 and 72 to form the alternating sidewall sections. After the plastic cures, the die elements 70 and 72 are pulled apart, and the apparatus is removed.

Although preferred embodiments of the present invention have been described above by way of example, it will be understood by those skilled in the field that modifications may be made to the disclosed embodiments which are within the scope of the invention as defined by the appended claims.

What is claimed is:

1. An apparatus for retaining a length of fiber optic cable having a given diameter and corresponding minimum bend radius in an aerial installation, comprising:
deck means for defining a generally planar surface, said deck means having a periphery;
channel means for retaining the length of fiber optic cable, said channel means extending around the periphery of said deck means such that the channel means includes a curved portion, said channel means comprising a bottom wall and opposing sidewalls;
wherein said sidewalls are generally parallel to said planar surface and wherein each said sidewall comprises alternating sidewall sections such that a section of one sidewall is not opposed by a section on the opposing sidewall; and
wherein said curved portion of said channel means has a radius not less than the corresponding minimum bend radius.

2. The apparatus as recited in claim 1 wherein said channel means includes an entry port and an exit port, said entry port and exit port being in close proximity.

3. The apparatus as recited in claim 1 wherein each alternating sidewall section of each sidewall is separated by a distance, said distance being at least equal to the length of the opposing alternating sidewall section of the opposing sidewall.

4. The apparatus as recited in claim 1 wherein said bottom wall is generally perpendicular to said planar surface.

5. The apparatus as recited in claim 1 wherein said alternating sidewall sections are generally rectangular.

6. A method of manufacturing an apparatus for retaining a length of fiber optic cable having a given diameter and corresponding minimum bend radius in an aerial installation comprising:
constructing opposing die halves for molding the apparatus;
moving the opposing die halves together such that a space is defined between the die halves, said space defining:
a deck defining a generally planar surface, said deck having a periphery;
a channel for retaining the length of fiber optic cable, said channel extending around the periphery of said deck such that the channel includes a curved portion having a radius not less than the corresponding minimum bend radius, said channel comprising a bottom wall and opposing sidewalls, said sidewalls being generally parallel to said planar surface and comprising alternating sidewall sections such that a section of one sidewall is not opposed by a section on the opposing sidewall; and
injecting a fluid plastic substance into the space between the opposing die halves;
letting the fluid plastic cure for a predetermined time; and
separating the opposing die halves.
